(19) United States
(12) Patent Application Publication
(10) Pub. No.: US 2014/0281964 A1
(43) Pub. Date: Sep. 18, 2014

(54) METHOD AND SYSTEM FOR PRESENTING GUIDANCE OF GESTURE INPUT ON A TOUCH PAD

(71) Applicants: Maung Han, Torrance, CA (US); Hikaru Wako, Torrance, CA (US); Takahisa Iwai, Torrance, CA (US)

(72) Inventors: Maung Han, Torrance, CA (US); Hikaru Wako, Torrance, CA (US); Takahisa Iwai, Torrance, CA (US)

(21) Appl. No.: 13/827,907

(22) Filed: Mar. 14, 2013

(51) Int. Cl. G06F 3/01

(52) U.S. Cl. CPC G06F 3/017
USPC 715/708

(57) ABSTRACT

A method of presenting guidance of gesture input on a touch pad having a touch screen and a touch sensor and coupled to an infotainment system including a first screen in a vehicle, includes predicting one or more gestures available under a current control context at the infotainment system, generating one or more graphics corresponding with the one or more gestures, detecting a gesture on the touch screen by the touch sensor and transmitting the detected gesture to the infotainment system and displaying the one or more graphics.

### BACKGROUND

1. Field

The present disclosure relates to a method and system for presenting guidance of gesture input on a touch pad. More specifically, embodiments in the present disclosure relate to a method and system for presenting guidance of gesture input on a touch pad such that a touch pad provides guidance of possible gesture input via displaying simple and vivid graphics, sound signaling, haptic presentation, etc., in order to provide a user intuitive and friendly gesture guidance while preventing from driver distraction.

2. Description of the Related Art

While a driver is driving a vehicle, it is not easy for the user to touch a screen of an infotainment system in the vehicle and control the infotainment system as intended, due to instability and vibration in the vehicle. This operation often requires a driver's eyes off the road and this may lead to the driver distraction, which is dangerous for driving. Thus, it would be more favorable, if the driver can have access to an input device for the infotainment system which has an interface that the user is already familiar which does not require the driver's attention with eyes. As one of an interface device that many drivers are familiar with is a smartphone, which may be used as a remote input.

Alternatively, a remote controller on the steering wheel is becoming popular, since the driver's hands are usually on the steering wheel and it would be efficient for a driver to operate the remote controller on the steering wheel. Thus, it is possible to have such an interface device on the steering wheel.

However, a size of the remote touch screen of the smartphone or steering wheel as considered above can be much smaller than a size of the screen of the infotainment console and the eyes are mostly off the remote touch screen because driving tends to require the user to keep eyes on the road. Thus, the driver may not perform an appropriate gesture, even though the user tends more familiar with touch interaction with the remote touch screen than touch interaction with the screen of the infotainment system. The user may have limited time to pay attention to the remote touch screen.

Accordingly, there is a need to provide a method and system that allows a user to easily recognize a gesture to be performed to operate the infotainment system in the vehicle, without duplicate gestures, in order to provide less stressful user interface across the vehicle infotainment system and the remote touch screen.

### SUMMARY

In one aspect, a method of presenting guidance of gesture input on a touch pad having a touch screen and a touch sensor and coupled to an infotainment system including a first screen in a vehicle is provided. The method includes predicting one or more gestures available under a current control context at the infotainment system and generating one or more graphics corresponding with the one or more gestures. The method also includes detecting a gesture on the touch screen by the touch sensor and transmitting the detected gesture to the infotainment system. The method further includes displaying the one or more graphics.

In another aspect, a non-transitory computer readable medium storing computer executable instructions for implementing a method of presenting guidance of gesture input on a touch pad including a touch screen and a touch sensor and coupled to an infotainment system including a first screen in a vehicle is provided.

In one embodiment, one or more graphics are displayed when the detected gesture does not correspond with any of the predicted one or more gestures.

In one embodiment, one or more graphics corresponding with one or more gestures are displayed in a distinguishable manner using graphically different attributes, if one or more gestures are predicted to be available under a current control context.

In one embodiment, one or more graphics are displayed with tactile presentation.

In another aspect, a touch pad coupled to an infotainment system including a first screen in a vehicle is provided. The touch pad includes a communication interface which communicates with the infotainment system, a second screen that displays an image, a touch sensor that senses a contact of an object and a touch related controller that processes a result of sensing at the touch sensor. The second screen presents a guidance of movement corresponding to an expected movement of a user for entering a command to the infotainment system, in response to at least one item on the first screen of the infotainment system.

In one embodiment, the touch related controller detects a movement of the user and the communication interface transmits the movement to the infotainment system, and receives a command from a infotainment system indicative of instructing the second screen to present the guidance of the movement.

In one embodiment, the touch pad is located on a smartphone.

In one embodiment, the touch pad is located on a steering wheel.

In one embodiment, the touch pad is the first screen on the infotainment console.

In one aspect, a vehicle infotainment system including a central processing unit, a first screen, and a communication interface that communicates with an external device including a touch screen is provided. The central processing unit instructs the communication interface to detect whether the external device is available when the car is on, and instructs the communication interface to send a command to the external device to activate the touch application, if the external device is available when the car is on. The central processing unit predicts one or more gestures available under a current control context, generates one or more graphics corresponding with the one or more gestures, and instructs the communication interface to send a command to the external device instructing the external device to display the generated one or more graphics.

In one embodiment, the central processing unit receives a command from the external device via the communication interface, indicating that the external device has detected a touch gesture operation, and instructs the communication interface to send a command to the external device instructing the external device to display when the detected gesture does not correspond with any of the predicted one or more gestures.

In one embodiment, the central processing unit instructs the communication interface to send a command to the external device, instructing the external device to display one or more graphics corresponding with one or more gestures in a distinguishable manner using graphically different attributes, if one or more gestures are predicted to be available under a current control context.

In one embodiment, the central processing unit instructs the communication interface to send a command to the external device, instructing the external device to display one or more graphics accompanied with tactile presentation, if the communication interface has received a notification from the external device that the external device is able to process tactile presentation.

The above and other aspects, objects and advantages may best be understood from the following detailed discussion of the embodiments.

### BRIEF DESCRIPTION OF THE DRAWINGS

FIG. 1 is a block diagram of an infotainment console in a vehicle and a smartphone, according to one embodiment.

FIG. 2A is a schematic diagram of an infotainment console in a vehicle and a smartphone, according to one embodiment.

FIG. 2B shows a schematic diagram of wireless connection between an infotainment console in a vehicle and a smartphone, according to one embodiment.

FIG. 2C shows a schematic diagram of bus connection between an infotainment console in a vehicle and a smartphone, according to one embodiment.

FIG. 2D is a block diagram of a smartphone with a touch screen, according to one embodiment.

FIG. 3 shows screen examples of a smartphone as a remote touch controller providing gesture guidance, according to one embodiment.

FIG. 4 shows screen examples of a smartphone as a remote touch controller providing gesture guidance and corresponding screen examples of a vehicle infotainment console, according to one embodiment.

FIG. 5 is a block diagram of an infotainment console in a vehicle and a steering wheel with one or more touch screens, according to one embodiment.

FIG. 5A is a schematic diagram of an infotainment console in a vehicle and a steering wheel with one or more touch screens, according to one embodiment.

FIG. 5B shows a schematic diagram of bus connection between an infotainment console in a vehicle and a steering wheel with one or more touch screens, according to one embodiment.

FIG. 5C shows a schematic diagram of wireless connection between an infotainment console in a vehicle and a steering wheel with one or more touch screens, according to one embodiment.

FIGS. 6A-6I show screen examples of one or more touch screens on a steering wheel providing gesture guidance, according to one embodiment.

FIG. 7 shows screen examples of a steering wheel as a remote touch controller providing gesture guidance and corresponding screen examples of a vehicle infotainment console, according to one embodiment.

FIGS. 8A and 8B are a schematic diagram of an infotainment console in a vehicle including one or more touch screens, according to one embodiment.

FIGS. 9A and 9B are a schematic diagram of an infotainment console in a vehicle and an image generator, according to one embodiment.

FIGS. 10A and 10B are a schematic diagram an infotainment console in a vehicle and a camera, according to one embodiment.

FIG. 11 shows screen examples of an infotainment console providing gesture guidance, according to one embodiment.

FIG. 12 is a block diagram of an infotainment console in a vehicle and a tactile touch console with one or more touch screens and tactile controller, according to one embodiment.

FIG. 13 shows screen examples of one or more touch screens with convex and concave tactile presentation providing gesture guidance, according to one embodiment.

FIG. 14 shows screen examples of one or more touch screens with vibration tactile presentation providing gesture guidance, according to one embodiment.

FIG. 15 shows screen examples of one or more touch screens with registration of a gesture operation and gesture guidance based on the gesture guidance, according to one embodiment.

FIG. 16 is a flow chart of providing gesture guidance according to one embodiment.

FIG. 17 is a flow chart of providing gesture guidance according to another embodiment.

### DETAILED DESCRIPTION OF THE PREFERRED EMBODIMENTS

Various embodiments for the method and system of presenting guidance of gesture input on a touch pad will be described hereinafter with reference to the accompanying drawings. Unless defined otherwise, all technical and scientific terms used herein have the same meaning as commonly understood to one of ordinary skill in the art to which present disclosure belongs. Although the description will be made mainly for the case where the method and system method and system of presenting guidance of gesture input on a touch pad, any methods, devices and materials similar or equivalent to those described, can be used in the practice or testing of the embodiments. All publications mentioned are incorporated by reference for the purpose of describing and disclosing, for example, the designs and methodologies that are described in the publications which might be used in connection with the presently described embodiments. The publications listed or discussed above, below and throughout the text are provided solely for their disclosure prior to the filing date of the present disclosure. Nothing herein is to be construed as an admission that the inventors are not entitled to antedate such disclosure by virtue of prior publications.

In general, various embodiments of the present disclosure are related to a method and system of presenting guidance of gesture input on a touch pad. Furthermore, the embodiments are related to a method and system for presenting guidance of gesture input on a touch pad such that a touch pad provides guidance of possible gesture input via displaying simple and vivid graphics, sound signaling, haptic presentation, etc., in order to provide a user intuitive and friendly gesture guidance while preventing from driver distraction.

FIG. 1 is a block diagram of an infotainment console in a vehicle and a smartphone that executes a method and system for presenting guidance of gesture input on a touch pad according to one embodiment. Note that the block diagram in FIG. 1 is merely an example according to one embodiment for an illustration purpose and not intended to represent any on particular architectural arrangement. The various embodiments can be applied to other type of vehicle infotainment system implemented by vehicle head unit. For example, the vehicle infotainment console 100 includes a central processor unit (CPU) 101 for controlling an overall operation of the infotainment console, a buffer memory 102 for temporally storing data such as a current user interface related data for efficient handling user inputs in accordance with this disclosure, random access memory (RAM) 103 for storing a processing result, and read only memory (ROM) 104 for storing various control programs, such as a user interface control program and an audio visual media and navigation control program, necessary for infotainment system control of this disclosure.

The infotainment console 100 also includes a data storage medium 105 such as a hard disk in a hard disk drive (HDD), flash memory in a solid state drive (SSD) or universal serial bus (USB) key memory, a compact disc-read only memory (CD-ROM), a digital versatile disc (DVD) or other storage medium for storing navigation and entertainment contents such as map information, music, video etc. The infotainment console also includes a control unit 106 for controlling an operation for reading the information from the data storage medium 105. The infotainment console 100 may include or have access to a position/distance measuring device 109 in a vehicle and either inside or at proximity of the infotainment console 100, for measuring a present vehicle position or user position, which may be associated with a preset table. For example, the position measuring device 109 has a vehicle speed sensor for detecting a moving distance, a gyroscope for detecting moving direction, a microprocessor for calculating a position, a global positioning system (GPS) received for receiving and analyzing GPS signals, etc., and each connected by an internal bus system 110.

The infotainment console 100 further includes a map information memory 107 for storing a portion of the map data relevant to ongoing operations of the infotainment console 100 which is read from the data storage medium 105, a point of interest (POI) database memory 108 for storing database information such as POI information which is read out from the data storage medium 105.

The infotainment console 100 accommodates a plurality of means for receiving user inputs. For example, the infotainment console 100 may include a bus controller 112 externally for coupling to an external device via a bus 122 (e.g. Universal Serial Bus, etc.) and a bus controller interface 111 handles received data from the external device. In one embodiment, the bus 122 may be used for receiving user inputs from a smartphone 119 that accepts one or more user touch gesture operations via a touch screen 120.

Furthermore, the infotainment console 100 may include a wireless transmitter/receiver 113. Using the wireless transmitter/receiver 113 via antenna 114, the infotainment console 100 may communicate with external devices inside the vehicle, external devices surrounding vehicles, remote servers and networks, etc. In this embodiment, the wireless transmitter/receiver 113 may be used for receiving user inputs from a smartphone 119 that accepts one or more user touch gesture operations via a touch screen 120, as well as transmitting a graphical signal to be presented to a user.

A smartphone 119 may include a communication interface 121 that handles wired/wireless communication with the infotainment console 100 via the bus 122 and/or the wireless transmitter/receiver 113, a touch screen 120 which receives touch entries of a user, and a central processing unit (CPU) 129 which processes the entries from the user. A smartphone 119 is one example of an external device to be paired with the infotainment console 100 for providing a user interface, and the infotainment console 100 may receive touch entries from various other input devices, to achieve the same and similar operations done through the smartphone 119, as shown later in other embodiments.

For example, the infotainment console 100 may include a screen 118, which may present a natural view as an interface to a user. This may be, but not limited to, a touch screen for detecting a touch entry by the user. Alternatively, as seen in a traditional vehicle entertainment system, knobs 123 and buttons 124 may be included in the infotainment console 100 for accommodating entries by a user. To accommodate hands-free input operation to avoid driver distraction, it may be appropriate to use voice commands as user inputs for the infotainment console 100. To accommodate such voice commands, a microphone 125 for receiving speech input may be included. Once a voice command is received at the microphone 125, the voice command is sent to a speech recognizer 126 to be matched with any speech pattern associated with infotainment related vocabulary in a speech database and the matched speech pattern is interpreted as a voice command input from the user.

The vehicle infotainment console 100 may also include a plurality of means to output an interactive result of user input operations. For example, the infotainment console 100 may include a display controller 115 for generating images, such as tuning preset table images, as well as menu related images related to the infotainment console control information and the some of these generated images may be stored in a video RAM (VRAM) 116. The images stored in the VRAM 116 are sent to a video generating unit 117 where the images are converted to an appropriate format to be displayed on a screen 118. Upon the receipt of video data, the screen 118 displays the image. Alternatively, to keep eyes of a driving user on a road rather than prompting the driving user to look in to the screen, the interactive output may be presented to the driving user as audio feedback via one or more speakers 127.

The bus system 110 may include one or more busses connected to each other through various adapters, controllers, connectors, etc. and the devices and units of the infotainment console 100 mentioned the above may be coupled to each other via the bus system 110.

The CPU 101 controls an overall operation of the infotainment console 100 including receiving entries of a user, processing the entries, displaying interaction to the user accordingly, selecting a content or control item from either a medium, a connected device, or a broadcast signal and presenting the content or control item to the user.

While a user is driving and the vehicle is moving, it is not easy for the user to touch a screen 118 on and control the infotainment console 100 as intended, due to instability and vibration in the vehicle. Thus, it would be more favorable, if the user can have access to an input device for the infotainment console 100 which has an interface that the user is already familiar. In one embodiment, a smartphone 119 of the user may be used as a remote input device that has an interface familiar to the user.

According to one embodiment, the smartphone 119 may be placed in proximity to the user and an infotainment console 100 as shown in FIG. 2A. In fact, the smartphone 119 may be placed anywhere, which allows easy access from the user, as far as the smartphone 119 can secure its wired or wireless communication with the infotainment console 100. The smartphone 119 may be paired to the infotainment console 100 via a wireless communication, such as BlueTooth, WiFi, InfraRed, etc., as shown in FIG. 2B. Alternatively, the smartphone 119 may be paired to the infotainment console 100 via a bus, such as Universal Serial Bus (USB), etc., as shown in FIG. 2C.

Depending on a context, such as whether the infotainment console 100 is in a navigation mode, entertainment mode, information access mode, control mode, etc., the infotainment console 100 expects a touch operation as an entry from a user. Here, the user's eyes tend to be on a road ahead and around of the vehicle that the user is driving, the user can have very short time to pay attention to the screen 118 of the infotainment console 100 or the touch screen 120 of the smartphone 119 as a remote touch pad. Because the infotainment console 100 expects limited kinds of touch operation according to the context, the infotainment console 100 may be able to transmit the expected kinds of touch operation to the smartphone 119, via wired/wireless communication, as indicated in FIGS. 2A-2C.

FIG. 2D is a block diagram of the smartphone 119 with a touch screen 120. The touch screen may be of any type, such as resistive, capacitive, optical, acoustic, etc. In the touch screen 120, one or more touch sensors 201 may be equipped in order to detect touch gestures of the user. The smartphone 119 contains a communication interface 121 for controlling wireless or wired communication and a central processor unit (CPU) 129. The CPU 129 processes operations of the smartphone 119, including operations for controlling graphic display on the touch screen 120 as well as operations for detecting touch gestures sensed by the one or more touch sensors 201 on the touch screen 120. While driving, the touch screen 120 may be displaying a home screen or a blank screen that does not allow user interaction in order to prevent from driver distraction. Alternatively, the touch screen 120 may display rulers or grids on a blank screen in order to aid the user to recognize the touch screen 120 even though there may be no content or control object displayed on the touch screen 120.

When a user wishes to operate the infotainment console 100 from the touch screen 120 of the smartphone 119 as a remote touch controller, the user starts touching the touch screen 120. The user's touch operation is similar to touch operation on the screen 118 of the infotainment console 100. However, a size of the touch screen 120 of the smartphone 119 is different from a size of the screen 118 of the infotainment console 100 and the eyes are mostly off the touch screen 120 of the smartphone 119 due to the fact that driving tends to require the user to keep eyes on the road during driving. Thus, the user may not provide an appropriate gesture, even though the user tends more familiar with touch interaction with the touch screen 120 of the smartphone 119 than touch interaction with the screen 118 of the infotainment console 100. The user may have limited time to pay attention to the touch screen 120 of the smartphone 119.

FIG. 3 shows screen examples of a smartphone as a remote touch controller providing gesture guidance, according to one embodiment. For example, In FIG. 3, the screen examples (a), (b), (c) and (d) correspond to guidance screens of swiping left, swiping right, swiping up and swiping down, respectively, where the touch screen 120 is indicating that the user is expected to provide a particular swipe gesture. Also, in FIG. 3, the screen examples (e) and (f) correspond to multi-touch gesture guidance screens of pinching out and pinching in, respectively, where the touch screen 120 is indicating that the user is expected to provide a particular multi-touch gesture.

It is often the case that there are several gesture entry options available upon a context of controlling. Thus, it is more helpful if the guidance on the touch screen 120 is able to indicate the several options. For this purpose, a plurality of gesture options may be indicated in a distinctive manner. For example, the screen example (g) in FIG. 3 corresponds to a gesture guidance screen of swiping up in one color and swiping down in another color on the touch screen 120, where the touch screen 120 is indicating that the user is expected to provide one of a plurality of particular swipe gesture options. For another example, the screen example (h) in FIG. 3 corresponds to a multi-touch gesture guidance screen of pinching out in one color and pinching in in another color on the touch screen 120, respectively, where the touch screen 120 is indicating that the user is expected to provide one of a plurality of particular multi-touch gesture options. These gesture options may be distinguished by any graphically different attributes, such as patterns, textures, edge patterns etc., not limited to colors as shown in the screen examples (g) and (h) in FIG. 3.

In another embodiment, as shown in the screen examples (i) and (j) in FIG. 3, it is possible to indicate a plurality of options of different kinds allowed to the user on the touch screen 120. For example, the screen example (i) in FIG. 3 indicates swiping up, swiping down, swiping right, swiping left, and making a circle are options available for the user. In another embodiment, as shown in the example (j) in FIG. 3, a plurality of gesture options, such as pinching in, pinching out, and making a circle are possible for the user input. These gesture options may be distinguished by any graphically different attributes, such as patterns, textures, edge patterns etc., not limited to colors as shown in the screen example (j) in FIG. 3.

In another embodiment, as shown in the screen examples (k) and (1) in FIG. 3, it is possible to indicate a status of the infotainment console 100 on the touch screen 120, whether the infotainment console 100 is available to accept an entry of a user on the touch screen 120. For example, the touch screen 120 may be black out or in red, as shown in the screen example (k) in FIG. 3, in order to indicate that the infotainment console 100 is not able to accept any input. Alternatively, the touch screen 120 may positively indicate with an icon, for example, of inability of the infotainment console 100 to accept entries from the user.

To assist a gesture input operation of the user, it is possible to indicate an initial touch position where the gesture input operation should start, as shown in the screen examples (m), (n) and (o) in FIG. 3, as a part of the graphic display on the touch screen 120. As shown in the screen examples (m) and (n), the touch screen 120 may be able to indicate positions with relatively large circles, for example, which are more likely to be detected correctly by the touch screen 120 that the user initiated the entry gesture. Thus, the user can perform gesture input operations that are more likely to be accepted by the infotainment console 100. It is also possible to indicate a gesture of the user corresponding to touch gesture guidance arrows together. As shown in the screen example (o), the touch screen 120 may display arrows showing an expected pinching out operation together with a hand gesture of pinching out, for example.

In another embodiment, the touch gesture operation can also be indicated by gradually displaying an arrow on the touch screen 120, not only by displaying a complete arrow, as shown in the screen examples (p), (q) and (r) in FIG. 3. In the screen example (p) in FIG. 3, the touch screen 120 shows an initial growth of the arrow from right. In the screen example (q) in FIG. 3, the touch screen 120 shows the arrow with the progressed growth from right. In the screen example (r) in FIG. 3, the touch screen 120 shows the complete arrow pointing left. The portion in the arrow still inactive may be indicated with dotted lines as shown in the screen examples (p), (q) and (r) in FIG. 3. Alternatively, the inactive portion may be indicated in a less vivid color, such as gray out, etc. By displaying a gradually developing arrow corresponding to an expected gesture operation, it assists the user to easily understand the expected gesture operation without paying much attention to the touch screen 120 and thus, it may be possible to minimize a driver's distraction by performing the gesture operation.

FIG. 4 shows examples of expected gesture touch operations on the touch screen 120 and their corresponding functional operations for the infotainment console 100. For example, as shown in the screen sample (a) of FIG. 4, making a circle on the touch screen corresponds to an operation of increasing an audio volume of the infotainment console 100. Here, the touch screen may merely indicate a graphical guidance for making a circle. In another screen example (b) of FIG. 4, a gesture “swiping right” for changing a song back to a previous song on the infotainment console 100 is indicated on the touch screen with an arrow pointing right, indicating that “swiping right” gesture is expected to be performed on the touch screen. In another screen example (c) of FIG. 4, when a gesture “swiping down” for changing a source of contents to be play back on the infotainment console 100 is expected, the touch screen may indicate an arrow pointing the bottom for guiding “swiping down” gesture to guide the user to perform the swiping down gesture operation.

In another embodiment, FIG. 5 is a block diagram of an infotainment console in a vehicle and at least one touch screen on a steering wheel that executes a method and system for presenting guidance of gesture input on the at least one touch screen according to one embodiment. Note that the block diagram in FIG. 5 is merely an example according to one embodiment for an illustration purpose and not intended, to represent any on particular architectural arrangement. The various embodiments can be applied to other type of vehicle infotainment system implemented by vehicle head unit. The vehicle infotainment console 500 includes a hardware configuration similar to FIG. 1. Further, FIG. 5 shows a configuration of touch screen system on a steering wheel 519.

The bus system 510 may include one or more busses connected to each other through various adapters, controllers, connectors, etc. and the devices and units of the infotainment console 500 mentioned the above may be coupled to each other via the bus system 510.

The infotainment console 500 accommodates a plurality of means for receiving user inputs. For example, the infotainment console 500 may include a bus controller 512 externally for coupling to a steering wheel 519 via a bus 522 (e.g. Universal Serial Bus, etc.) and a bus controller interface 511 handles received data from the external device. In one embodiment, the bus 522 may be used for receiving user inputs from the steering wheel 519 that accepts one or more user touch gesture operations via a touch screen 520. Alternatively, this wired communication between the infotainment console 500 may include and the steering wheel 519 may be achieved by the bus system 510.

Furthermore, the infotainment console 500 may include a wireless transmitter/receiver 513. Using the wireless transmitter/receiver 513 via antenna 514, the infotainment console 500 may communicate with external devices inside the vehicle, external devices surrounding vehicles, remote servers and networks, etc. In this embodiment, the wireless transmitter/receiver 513 may be used for receiving user inputs from the steering wheel 519 that accepts one or more user touch gesture operations via a touch screen 520, as well as transmitting a graphical signal to be presented to a user.

A steering wheel 519 may include a communication interface 521 that handles wired/wireless communication with the infotainment console 500 via the bus 522 and/or the wireless transmitter/receiver 513, a touch screen 520 which receives touch entries of a user, and a touch controller 529 which processes the entries from the user. A steering wheel 519 is one example of an external device to be paired with the infotainment console 500 for providing a user interface, and the infotainment console 500 may receive touch entries from various other input devices, to achieve the same and similar operations done through the steering wheel 519, as shown earlier in other embodiments.

For example, the infotainment console 500 may include a screen 518, which may present a natural view as an interface to a user. This may be, but not limited to, a touch screen for detecting a touch entry by the user. Alternatively, as seen in a traditional vehicle entertainment system, knobs 523 and buttons 524 may be included in the infotainment console 500 for accommodating entries by a user. The vehicle infotainment console 500 may also include a plurality of means to output an interactive result of user input operations. For example, the infotainment console 500 may include a display controller 515 for generating images, such as tuning preset table images, as well as menu related images related to the infotainment console control information and the some of these generated images may be stored in a video RAM (VRAM) 516. The images stored in the VRAM 516 are sent to a video generating unit 117 where the images are converted to an appropriate format to be displayed on a screen 518. Upon the receipt of video data, the screen 518 displays the image. Alternatively, to keep eyes of a driving user on a road rather than prompting the driving user to look in to the screen, the interactive output may be presented to the driving user as audio feedback via one or more speakers 527.

The CPU 501 controls an overall operation of the infotainment console 500 including receiving entries of a user, processing the entries, displaying interaction to the user accordingly, selecting a content or control item from either a medium, a connected device, or a broadcast signal and presenting the content or control item to the user.

While a user is driving and the vehicle is moving, it is not easy for the user to touch a screen 518 on and control the infotainment console 500 as intended, due to instability and vibration in the vehicle. Thus, it would be more favorable, if the user can have access to an input device for the infotainment console 500 which has a manual interface in a proximity to the user. In one embodiment, a steering wheel 519 may be used as a remote input device that can include a manual interface in a proximity to the user.

According to one embodiment, a steering wheel 519 may be attached to a vehicle in front of the user as shown in FIG. 5A. The steering wheel 519 may be paired to the infotainment console 500 via a bus, such as Universal Serial Bus (USB), etc., as shown in FIG. 513. Alternatively, the steering wheel 519 may be paired to the infotainment console 500 via a wireless communication, such as BlueTooth, WiFi, InfraRed, etc., as shown in FIG. 5C. Depending on a context, such as whether the infotainment console 500 is in a navigation mode, entertainment mode, information access mode, control mode, etc., the infotainment console 500 expects a touch operation as an entry from a user. Here, the user's eyes tend to be on a road ahead and around of the vehicle that the user is driving, the user can have very short time to pay attention to the screen 518 of the infotainment console 500 or the touch screen 520 of the steering wheel 519 as a remote touch pad. Because the infotainment console 500 expects limited kinds of touch operation according to the context, the infotainment console 500 may be able to transmit the expected kinds of touch operation to the steering wheel 519, via wired/wireless communication, as indicated in FIGS. 5A-5C.

FIG. 6A is a front view of the steering wheel 519 with touch screens 520. The touch screens may be of any type, such as resistive, capacitive, optical, acoustic, etc. In the touch screens 520, one or more touch sensors (not shown) may be equipped in order to detect touch gestures of the user. The touch screens 520 of the steering wheel 519 may be controlled by the CPU 501. While driving, the touch screens 520 may be displaying a home screen or a blank screen that does not allow user interaction in order to prevent from driver distraction. Alternatively, the touch screens 520 may display rulers or grids on a blank screen in order to aid the user to recognize the touch screens 520 even though there may be no content or control object displayed on the touch screens 520.

When a user wishes to operate the infotainment console 500 from the touch screens 520 of the steering wheel 519 as a remote touch controller, the user starts touching the one or more touch screens 520. The user's touch operation is similar to touch operation on the screen 518 of the infotainment console 500. However, a size of the touch screens 520 of the steering wheel 519 is different from a size of the screen 518 of the infotainment console 500 and the eyes are mostly off the touch screen 520 of the steering wheel 519 due to the fact that driving tends to require the user to keep eyes on the road during driving. Thus, the user may not provide an appropriate gesture, even though the user tends more familiar with touch interaction with the touch screen 520 of the steering wheel 519 than touch interaction with the screen 518 of the infotainment console 500. The user may have limited time to pay attention to the touch screen 520 of the steering wheel 519.

FIGS. 6B-6I show screen examples of one or more touch screens 520 on a steering wheel 519 as a remote touch controller providing gesture guidance, according to one embodiment. For example, in FIG. 613, the screen examples correspond to guidance screens of swiping left and right where the touch screens 520 are indicating that the user is expected to provide a particular swipe gesture. Also, in FIG. 6C, the screen examples correspond to guidance screens of swiping up and down where the touch screens 520 are indicating that the user is expected to provide a particular swipe gesture.

To assist a gesture input operation of the user, it is possible to indicate an initial touch position where the gesture input operation should start, as shown in the screen examples FIGS. 6D, 6E and 6F, as a part of the graphic display on the touch screens 520. As shown in FIGS. 6D, 6E and 6F, the touch screen 520 may be able to indicate positions with relatively large circles, for example, which are more likely to be detected correctly by the touch screen 520 that the user initiated the entry gesture. Thus, the user can perform gesture input operations that are more likely to be accepted by the infotainment console 500.

In another embodiment, it is possible to indicate a status of the infotainment console on the touch screen, whether the infotainment console is available to accept an entry of a user on the touch screen. For example, the touch screen may positively display an icon indicating inability of the infotainment console to accept entries from the user as shown in FIG. 6G. Alternatively, the touch screen may be black out or in red, in order to indicate that the infotainment console is not able to accept any input.

In another embodiment, it is possible to indicate a plurality of active areas for detecting an entry of gesture touch operation on the touch screen, corresponding to a plurality of function areas displayed on the infotainment console as shown in FIG. 6H.

In another embodiment, it is possible to indicate that the infotainment console is available to accept voice command only, not gesture touch operation. As shown in FIG. 6I, by indicating an icon of microphone, for example, the user is able to understand that the user is guided to provide voice commands instead of gesture touch operations.

FIG. 7 shows examples of expected gesture touch operations on the touch screen and their corresponding functional operations for the infotainment console. For example, as shown in the screen sample (a) of FIG. 7, an icon indicating inability of the infotainment console to accept entries from the user for the infotainment console 500 is displayed on the touch screens of the steering wheel. In another screen example (b) of FIG. 7, a plurality of active areas for detecting an entry of gesture touch operation are displayed on the touch screen of the steering wheel, where the plurality of active areas correspond to a plurality of function areas displayed on the screen the infotainment console. As shown in another screen example (c) of FIG. 7, by indicating an icon of microphone, for example, the user may be able to understand that the user is guided to provide voice commands instead of gesture touch operations in certain circumstances.

In another embodiment, it is possible to accept touch operations on a touch screen of an infotainment console 800. For example, as shown in FIG. 8A, the touch screen 818 may detect touch and accept gesture touch operations by a user, and the gesture touch guidance to assist the user's correct gesture touch operation may be implemented for displaying on the touch screen 818. The block diagram of this embodiment is shown in FIG. 8B.

In another embodiment, it is possible to display a gesture guidance anywhere in front of a user by displaying such a guidance from a projector 930 located behind the user. For example, as shown in FIG. 9A, a touch screen 918 may detect gesture from a captured gesture video and accept gesture operations by a user, and the gesture guidance to assist the user's correct gesture operation may be implemented for displaying on the screen 918. The block diagram of this embodiment is shown in FIG. 9B.

In another embodiment, it is possible to accept gesture operations on a touch screen 1018 of an infotainment console 1000 by detecting a gesture by a camera 1030 located behind the user. For example, as shown in FIG. 10A, an infotainment console 1000 may detect gesture from a captured gesture video and accept gesture operations by a user, and the gesture guidance to assist the user's correct gesture operation may be implemented for displaying on the screen 1018. The block diagram of this embodiment may be shown in FIG. 10B.

FIG. 11 shows examples of expected gesture touch operations displayed on the touch screen and their corresponding functional operations for the infotainment console. For example, as shown in the screen sample (a) of FIG. 11, making a circle on the touch screen corresponds to an operation of increasing an audio volume of the infotainment console. Here, the touch screen of the infotainment console may indicate a graphical guidance for making a circle overlaid on the original screen indicating functional operations. In another screen example (b) of FIG. 11, a gesture “swiping right” for changing a song back to a previous song on the infotainment console is indicated on the touch screen of the infotainment console with an arrow pointing right, indicating that “swiping right” gesture is expected to be performed on the touch screen. In another screen example (c) of FIG. 11, when a gesture “swiping down” for changing a source of contents to be play back on the infotainment console 100 is expected, the touch screen of the infotainment console may indicate an arrow pointing the bottom for guiding “swiping down” gesture to guide the user to perform the swiping down gesture operation.

In another embodiment, FIG. 12 is a block diagram of an infotainment console in a vehicle and at least one tactile touch console coupled to the infotainment console that executes a method and system for presenting guidance of gesture input on the at least one touch screen according to one embodiment. Note that the block diagram in FIG. 12 is merely an example according to one embodiment for an illustration purpose and not intended to represent any on particular architectural arrangement. The various embodiments can be applied to other type of vehicle infotainment system implemented by vehicle head unit. The vehicle infotainment console 1200 includes a hardware configuration similar to FIG. 1. Further, FIG. 12 shows a configuration of a tactile touch screen system 1228 coupled to the vehicle infotainment console 1200.

The bus system 1210 may include one or more busses connected to each other through various adapters, controllers, connectors, etc. and the devices and units of the infotainment console 1200 mentioned the above may be coupled to each other via the bus system 1210.

The infotainment console 1200 accommodates a plurality of means for receiving user inputs. For example, the infotainment console 1200 may include a bus controller 1212 externally for coupling to a touch pad 1219 via a bus 1222 (e.g. Universal Serial Bus, etc.) and a bus controller interface 1211 handles received data from the external device. In one embodiment, the bus 1222 may be used for receiving user inputs from the touch pad 1219 that accepts one or more user touch gesture operations via a tactile touch screen 1220. Alternatively, this wired communication between the infotainment console 1200 may include and the touch pad 1219 may be achieved by the bus system 1210.

Furthermore, the infotainment console 1200 may include a wireless transmitter/receiver 1213. Using the wireless transmitter/receiver 1213 via antenna 1214, the infotainment console 1200 may communicate with external devices inside the vehicle, external devices surrounding vehicles, remote servers and networks, etc. In this embodiment, the wireless transmitter/receiver 1213 may be used for receiving user inputs from the touch pad 1219 that accepts one or more user touch gesture operations via a touch screen 1220, as well as transmitting tactile signal to be presented to a user.

A touch pad 1219 may include a communication interface 1221 that handles wired/wireless communication with the infotainment console 1200 via the bus 1222 and/or the wireless transmitter/receiver 1213, a tactile touch screen 1220 which receives touch entries of a user and provides concavity and convexity or vibration to the user, and a touch controller 1229 which processes the entries from the user. A touch pad 1219 is one example of an external device to be paired with the infotainment console 1200 for providing a user interface, and the infotainment console 1200 may receive touch entries from various other input devices, to achieve the same and similar operations done through the touch pad 1219, as shown earlier in other embodiments.

For example, the infotainment console 1200 may include a screen 518, which may present a natural view as an interface to a user. This may be, but not limited to, a touch screen for detecting a touch entry by the user. Alternatively, as seen in a traditional vehicle entertainment system, knobs 1223 and buttons 1224 may be included in the infotainment console 500 for accommodating entries by a user. The vehicle infotainment console 500 may also include a plurality of means to output an interactive result of user input operations. For example, the infotainment console 1200 may include a display controller 1215 for generating images, such as tuning preset table images, as well as menu related images related to the infotainment console control information and the some of these generated images may be stored in a video RAM (VRAM) 1216. The images stored in the VRAM 1216 are sent to a video generating unit 1217 where the images are converted to an appropriate format to be displayed on a screen 1218. Upon the receipt of video data, the screen 1218 displays the image. Alternatively, to keep eyes of a driving user on a road rather than prompting the driving user to look in to the screen, the interactive output may be presented to the driving user as audio feedback via one or more speakers 1227.

The CPU 1201 controls an overall operation of the infotainment console 1200 including receiving entries of a user, processing the entries, displaying interaction to the user accordingly, selecting a content or control item from either a medium, a connected device, or a broadcast signal and presenting the content or control item to the user.

While a user is driving and the vehicle is moving, it is not easy for the user to touch a screen 1218 on and control the infotainment console 1200 as intended, due to instability and vibration in the vehicle. Thus, it would be more favorable, if the user can have access to an input device for the infotainment console 1200 which has a manual interface in a proximity to the user. In one embodiment, a touch pad 1219 may be used as a remote input device that can include a manual interface in a proximity to the user.

Depending on a context, such as whether the infotainment console 1200 is in a navigation mode, entertainment mode, information access mode, control mode, etc., the infotainment console 1200 expects a touch operation as an entry from a user. Here, the user's eyes tend to be on a road ahead and around of the vehicle that the user is driving, the user can have very short time to pay attention to the screen 1218 of the infotainment console 1200 or the touch screen 1220 of the touch pad 1219 as a remote touch pad. Because the infotainment console 1200 expects limited kinds of touch operation according to the context, the infotainment console 1200 may be able to transmit the expected kinds of touch operation to the touch pad 1219, via wired/wireless communication, as indicated in FIG. 12.

FIG. 13 shows screen examples of a tactile touch pad as a remote touch controller providing gesture guidance with concavity and convexity, according to one embodiment. For example, In FIG. 13, the screen examples (a), (b), (c) and (d) correspond to guidance screens of swiping left, swiping right, swiping up and swiping down, respectively, where the touch screen 1220 generates convex and concave surfaces to form an arrow signaling that the user is expected to provide a particular swipe gesture. Also, in FIG. 13, the screen examples (e) and (f) correspond to multi-touch gesture guidance screens of pinching out and pinching in, respectively, where the touch screen 1220 generates convex and concave surfaces to form a plurality of arrows indicating that the user is expected to provide a particular multi-touch gesture.

FIG. 14 shows screen examples of a tactile touch pad as a remote touch controller providing gesture guidance with vibration patterns, according to one embodiment. For example, In FIG. 14, the screen examples (a) and (b) correspond to multi-touch guidance screens of pinching out and pinching in, respectively, where the touch screen generates vibration patterns indicating that the user is expected to provide a particular multi-touch gesture.

In one embodiment, a user can register a touch gesture operation to be later used for touch gesture and guidance. For example, as shown in FIG. 15 (a), a user can register a certain gesture with free hand input on a screen. Later, as shown in FIG. 15 (b), the screen may be able to provide the expected gesture which was originally registered in (a) and smoothed out by signal processing.

FIG. 16 is a one sample flow chart of a procedure of the method of presenting guidance of gesture input on a touch pad according to one embodiment. In step S1601, a user gets in the vehicle with a smartphone. In step S1602, the smartphone is coupled to an infotainment console, when a vehicle is turned on. After the car is turned on, in step S1603, a touch application on the smartphone may be activated. The touch application activated on the smartphone also tries to hand shake with its corresponding infotainment console, in step S1603. If its corresponding infotainment console is not found, then the process is halted at step S1604. If its corresponding infotainment console is found, the infotainment console and touch application starts detecting a operation by a user at step S1605. While no entry has been received, the touch application keeps waiting in step S1605. Once a user action is received, the infotainment console proceeds to step S1606 to predict what touch gestures are acceptable according to a current context for controlling the infotainment console. Then the infotainment console transmits available gestures and its graphical/tactile information to the touch application of the touch pad in step S1607. The touch application presents available gestures on the touch screen to the user, in 51608. In this example, an external device is the smartphone, but it is not limited to the smartphone. Please note that any external device that can accomplish the similar procedure may be used for this purpose.

FIG. 17 is another sample flow chart of a procedure of the method of presenting guidance of gesture input on a touch pad according to one embodiment. In step S1701, a user gets in the vehicle with a smartphone. In step S1702, the smartphone is coupled to an infotainment console, when a vehicle is turned on. After the car is turned on, in step S1703, a touch application on the smartphone may be activated. The touch application activated on the smartphone also tries to hand shake with its corresponding infotainment console, in step S1703. If its corresponding infotainment console is not found, then the process is halted at step S1704. If its corresponding infotainment console is found, the infotainment console and touch application starts detecting a operation by a user at step S1705. While no entry has been received, the touch application keeps waiting in step S1705. Once a user action is received at the smartphone, the infotainment console proceeds to step S1706 in order to predict what touch gestures are acceptable according to a current context for controlling the infotainment console. At step S1707, if the user's action entry received at the smartphone corresponds with one of the predicted gestures, the infotainment console proceeds to process the user's action entry at step S1708. At step S1707, if the user's action entry received at the smartphone does not correspond with one of the predicted gestures, then the infotainment console transmits available gestures and its graphical/tactile information to the touch application of the touch pad in step S1709. The touch application presents available gestures on the touch screen to the user, in 51710. Please note that any external device that can accomplish the similar procedure may be used for this purpose.

Although this invention has been disclosed in the context of certain preferred embodiments and examples, it will be understood by those skilled in the art that the inventions extend beyond the specifically disclosed embodiments to other alternative embodiments and/or uses of the inventions and obvious modifications and equivalents thereof. In addition, other modifications which are within the scope of this invention will be readily apparent to those of skill in the art based on this disclosure. It is also contemplated that various combination or sub-combination of the specific features and aspects of the embodiments may be made and still fall within the scope of the inventions. It should be understood that various features and aspects of the disclosed embodiments can be combined with or substituted for one another in order to form varying mode of the disclosed invention. Thus, it is intended that the scope of at least some of the present invention herein disclosed should not be limited by the particular disclosed embodiments described above.

1. A method of presenting guidance of gesture input on a touch pad comprising a touch screen and a touch sensor and coupled to an infotainment system comprising a first screen in a vehicle, the method comprising:
predicting one or more gestures available under a current control context at the infotainment system;
generating one or more graphics corresponding with the one or more gestures;
detecting a gesture on the touch screen by the touch sensor;
transmitting the detected gesture to the infotainment system; and
displaying the one or more graphics.

2. The method of claim 1, wherein one or more graphics are displayed when the detected gesture does not correspond with any of the predicted one or more gestures.

3. The method of claim 1, comprising:
displaying one or more graphics corresponding with one or more gestures in a distinguishable manner using graphically different attributes, if one or more gestures are predicted to be available under a current control context.

4. The method of claim 1, comprising:
displaying one or more graphics accompanied with tactile presentation.

5. The method of claim 1, wherein the touch pad is located on a smartphone.

6. The method of claim 1, wherein the touch pad is located on a steering wheel.

7. The method of claim 1, wherein the touch pad is the first screen on the infotainment console.

8. A touch pad configured to couple to an infotainment system comprising a first screen in a vehicle, the touch pad comprising:
a communication interface configured to communicate with the infotainment system;
a second screen configured to display an image;
a touch sensor configured to sense a contact of an object and
a touch related controller configured to process a result of sensing at the touch sensor;
wherein the second screen is configured to present a guidance of movement corresponding to an expected movement of a user for entering a command to the infotainment system, in response to at least one item on the first screen of the infotainment system.

9. The touch pad of claim 8, wherein the touch related controller is configured to detect a movement of the user,
wherein the communication interface is configured to transmit the movement to the infotainment system, and to receive a command from a infotainment system indicative of instructing the second screen to present the guidance of the movement.

10. The touch pad of claim 8, wherein the touch pad is located on a smartphone.

11. The touch pad of claim 8, wherein the touch pad is located on a steering wheel.

12. The touch pad of claim 8, wherein the touch pad is the first screen on the infotainment console.

13. A vehicle infotainment system comprising:
a central processing unit;
a first screen; and
a communication interface configured to communicate with an external device comprising a touch screen;
wherein the central processing unit is configured to instruct the communication interface to detect whether the external device is available when the car is on;
wherein the central processing unit is configured to instruct the communication interface to send a command to the external device to activate the touch application if the external device is available when the car is on;
wherein the central processing unit is configured to predict one or more gestures available under a current control context;
wherein the central processing unit is configured to generate one or more graphics corresponding with the one or more gestures; and
wherein the central processing unit is configured to instruct the communication interface to send a command to the external device instructing the external device to display the generated one or more graphics.

14. The vehicle infotainment system of claim 13, wherein the central processing unit is configured to receive a command from the external device via the communication interface, indicating that the external device has detected a touch gesture operation; and
wherein the central processing unit is configured to instruct the communication interface to send a command to the external device instructing the external device to display when the detected gesture does not correspond with any of the predicted one or more gestures.

15. The vehicle infotainment system of claim 13, wherein the central processing unit is configured to instruct the communication interface to send a command to the external device, instructing the external device to display one or more graphics corresponding with one or more gestures in a distinguishable manner using graphically different attributes, if one or more gestures are predicted to be available under a current control context.

16. The vehicle infotainment system of claim 13, wherein the central processing unit is configured to instruct the communication interface to send a command to the external device, instructing the external device to display one or more graphics accompanied with tactile presentation, if the communication interface has received a notification from the external device that the external device is able to process tactile presentation.

17. A non-transitory computer readable medium storing computer executable instructions for implementing a method of presenting guidance of gesture input on a touch pad comprising a touch screen and a touch sensor and coupled to an infotainment system comprising a first screen in a vehicle, the method comprising:
predicting one or more gestures available under a current control context at the infotainment system;
generating one or more graphics corresponding with the one or more gestures;
detecting a gesture on the touch screen by the touch sensor;
transmitting the detected gesture to the infotainment system; and
displaying the one or more graphics.

18. The non-transitory computer readable medium of claim 17, wherein one or more graphics are displayed when the detected gesture does not correspond with any of the predicted one or more gestures.

19. The non-transitory computer readable medium of claim 17, comprising:
displaying one or more graphics corresponding with one or more gestures in a distinguishable manner using graphically different attributes, if one or more gestures are predicted to be available under a current control context.

20. The non-transitory computer readable medium of claim 17, comprising:
displaying one or more graphics accompanied with tactile presentation.
